(19) United States
(12) Patent Application Publication
(10) Pub. No.: US 2015/0251704 A1
(43) Pub. Date: Sep. 10, 2015

(54) Vehicle Attachment

(71) Applicant: Larry Davis, Natchez, MS (US)

(72) Inventor: Larry Davis, Natchez, MS (US)

(21) Appl. No.: 14/198,521

(22) Filed: Mar. 5, 2014

(51) Int. Cl. B62D 23/00; B62J 17/00

(52) U.S. Cl. CPC B62D 23/00; B62J 17/00

(57) ABSTRACT

The vehicle will support two or more passengers moving from Point A to Point B—the grocery store, a friend's house, to work or out on out-of-town trips. Because of its new ornamental design, the public will be pleased with its motorcycle and automobile characteristics. Passengers don't have to hold up the weight of the vehicle with their legs, compared to a two-wheel motorcycle. The public will enjoy the open seating compartment to Mother Nature, enjoying the hot or cold climate. The new vehicle will have its own heating and cooling system which can be adjusted by the passenger for climate control when there is a change in the temperature around them. Passengers will be seated in an open compartment, having fun, relieving stress, and seeing everything around them. Compared to a two-wheel motorcycle, the new vehicle is more visible on the road and highway, making it safer for passengers in case of a highway accident.

### REFERENCE

Application Ser. No. 61/962,824

Filing date, Nov. 18, 2013

### BACKGROUND

Subject Matter—Motorcycle, Passenger Vehicle, Cars, Trucks

This new vehicle attachment invention will attach to an existing vehicle already in the marketplace. It will add to or attach to that existing vehicle do from a little fabrication. This vehicle attachment will solve problems: It is easy to drive; passengers don't have to worry about holding up the weight of the vehicle; It is safer because of its new large, and visible ornamental design, compared to a two-wheel motorcycle.

### SUMMARY

I claim that the invention has the advantage of transporting two or more people and is easy to control. Its brakes will use the brake system of the existing vehicle; its steering will use the steering system of the existing vehicle.

I claim that the new invention has the advantage for older people, young people, and the handicapped; they can control the vehicle while seated in a straddled position, front to back, creating a new design.

I claim that the new invention has more safety advantages than a two-wheel motorcycle because of its large, visible appearance and its scorpion-like design.

### BRIEF DESCRIPTION OF SEVERAL VIEWS

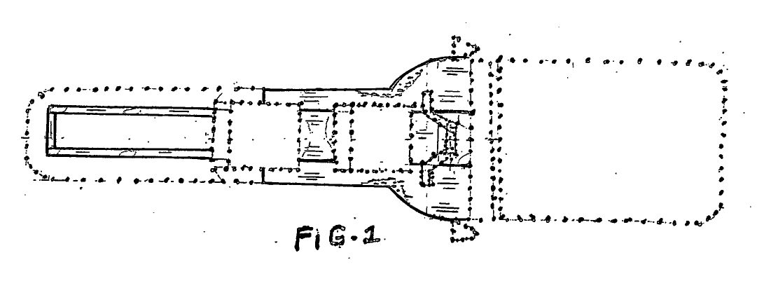

FIG. 1: A top elevation view of the new vehicle frame attachment attached to an existing vehicle frame showing a new design.

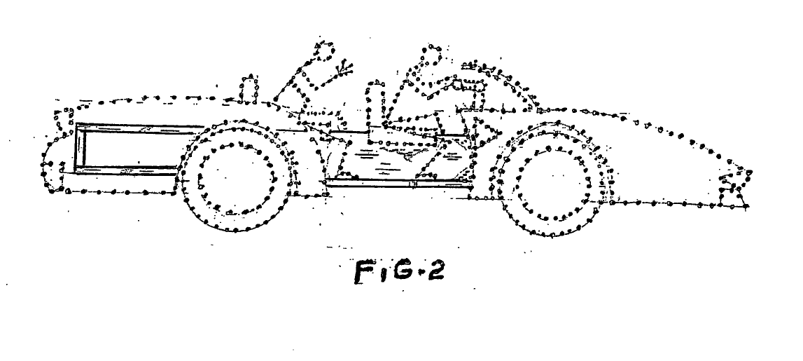

FIG. 2: A left side elevation view of the right side elevation view, being a mirror image. Both are views of the new vehicle frame attachment attached to an existing vehicle frame, showing a new design. These views show a new ornamental design to an existing product. Nothing will change, mechanically, on the existing vehicle from the dash board to the front bumper framework. The existing engine, transmission, steering system, brake system, cooling system, and heating system, will stay in place on the existing product-vehicle.

These views show a new ornamental design of an existing vehicle. From the dashboard framework to the rear bumper framework, this new vehicle frame is seen in place, supporting two or more passengers sitting straddled in a front to back positing, giving the new vehicle frame attachment which is mounted on one back wheel or two wheels, making a streamlined appearance, giving the existing vehicle a motorcycle appearance, thus creating a new ornamental design.

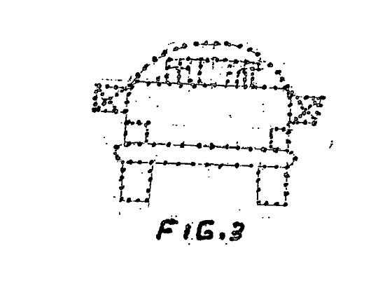

FIG. 3: A front elevation view of an existing vehicle with the new vehicle attachment attached, showing a streamlined appearance, thus showing a new design.

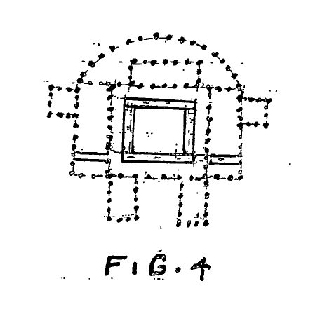

FIG. 4: A rear elevation view of the new vehicle frame attachment attached to an existing vehicle showing a new design.

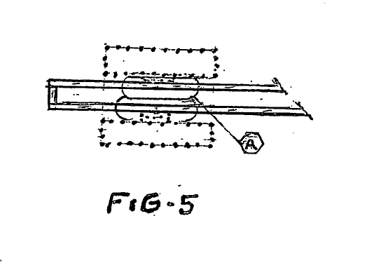

FIG. 5: A rear bottom view showing two wheels supporting the new vehicle frame attachment, showing a new design.

Detail A: A frame attachment view with welds or bolts connecting one or two wheels to the new vehicle frame attachment.

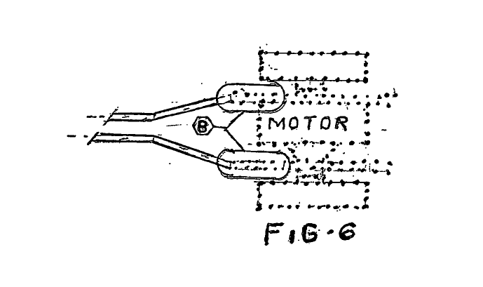

FIG. 6: A front bottom view of an existing vehicle frame attachment attached to the new vehicle frame attachment showing a new design.

Detail B: A frame attachment view showing welds or bolts connecting the new vehicle frame attachment attached to the existing vehicle frame showing a new design.

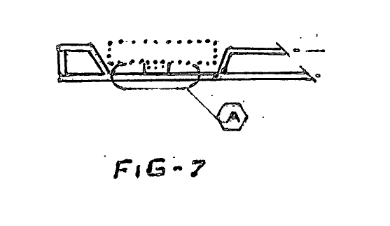

FIG. 7: A rear bottom view showing one wheel mounted on the new vehicle frame attachment showing a new design.

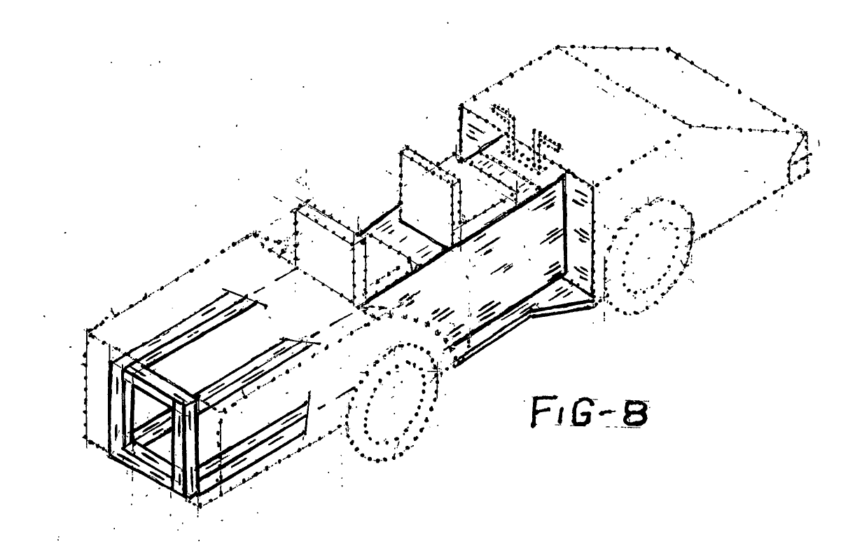

FIG. 8: A rear perspective view of the new vehicle frame attachment attached to an existing vehicle showing a new design.

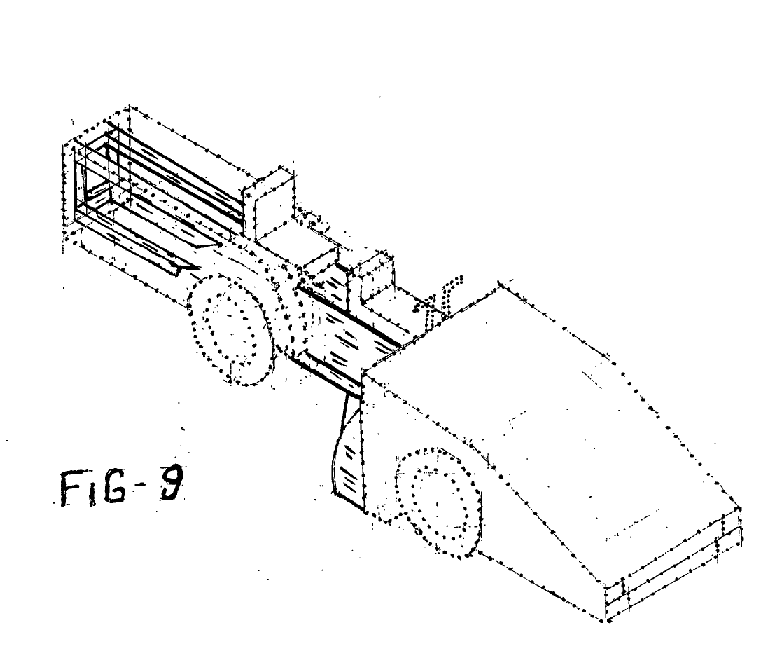

FIG. 9: A front perspective view of the new vehicle frame attachment attached to an existing vehicle showing a new design.

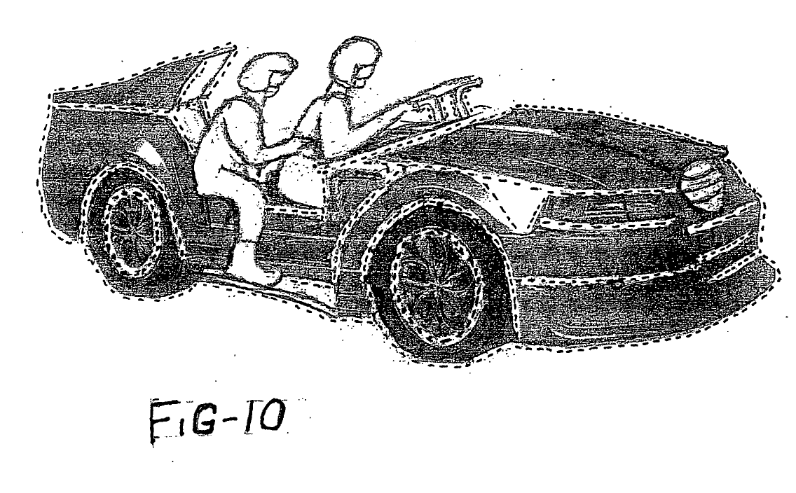

FIG. 10: An image view of the new vehicle frame attachment attached to an existing vehicle showing a new design.

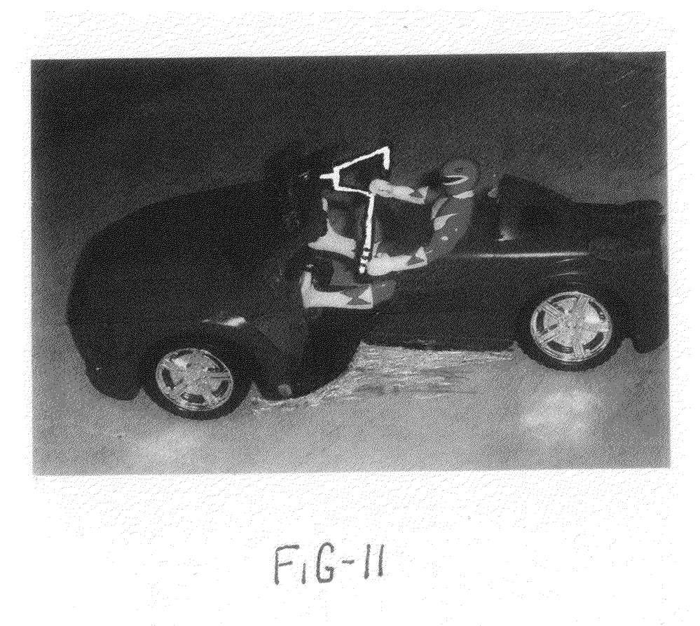

FIG. 11: A copy of a photo showing a model right side view of the finished product when the new vehicle frame attachment is attached to an existing vehicle frame showing a new design.

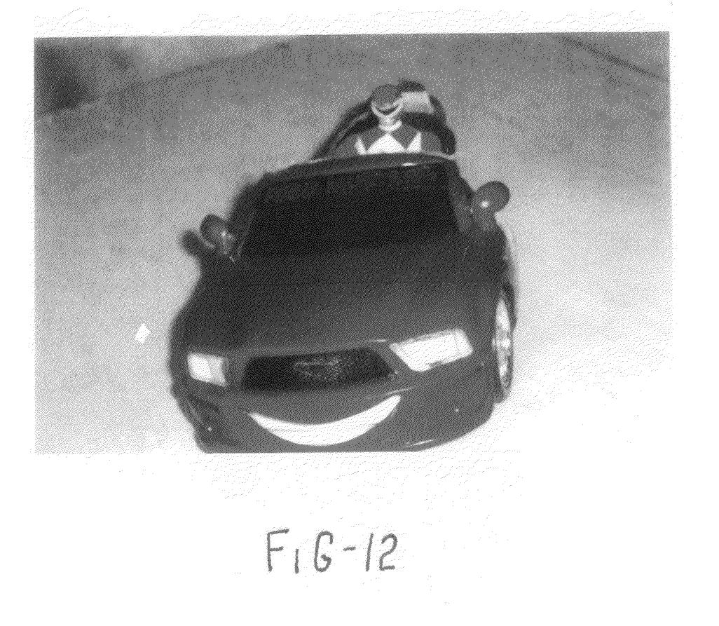

FIG. 12: A copy of a photo showing a model front view of the finished product when the new vehicle frame attachment is attached to an existing vehicle frame showing a new design.

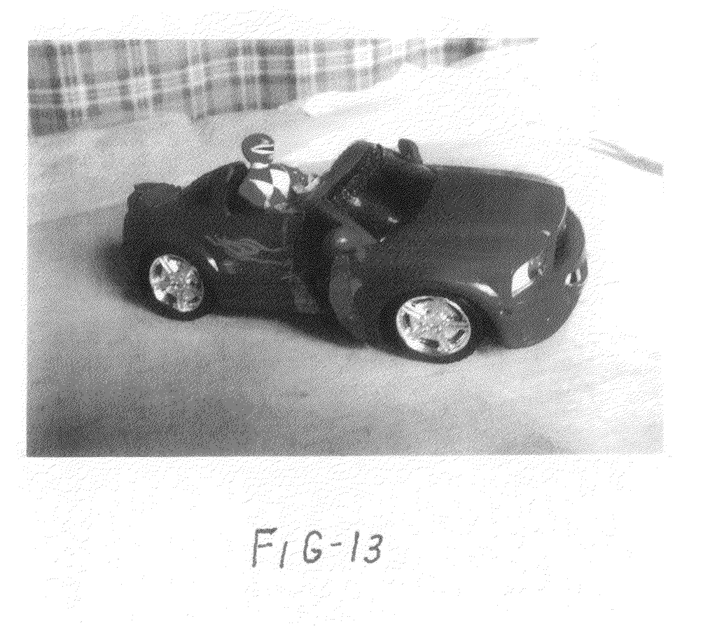

FIG. 13: A copy of a photo showing a model left side view of the finished product when the new vehicle frame attachment is attached to an existing vehicle frame showing a new design.

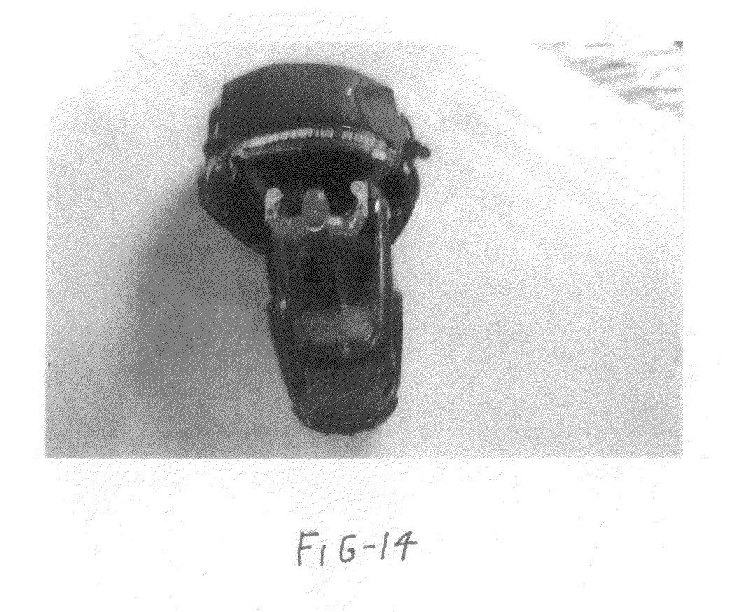

FIG. 14: A copy of a photo showing a model rear view of the finished product when the new vehicle frame attachment is attached to an existing vehicle frame showing a new design.

### DETAIL DESCRIPTION OF THE INVENTION

The process of making this new invention is to take an existing vehicle and take out the old seats in the passenger compartment, cut the top off the existing vehicle, cut and take out the metal floor board in the passenger compartment. A technician with metal and welding fabrication skills could do the work following the drawings and specifications in this application, creating a new ornamental design.

1. I claim that the new vehicle attachment framework invention has not been. It is a new concept to add to an existing vehicle frame as shown in FIG. 6.

2. I claim that the new vehicle attachment fame can support two or more passengers seated in a straddles position, front to back, making a stream like appearance. It is a new concept to add to an existing vehicle frame as shown in FIG. 1, FIG. 2, and FIG. 8.

3. I claim that the new vehicle attachment frame can support a handle bar or steering wheel device, creating a new design as shown in FIG. 1 and FIG. 8.

4. I claim that the new vehicle attachment frame can be supported by one wheel or two wheels, thus creating a new design to an existing vehicle as shown in FIG. 2, FIG. 5, and FIG. 7.

5. I claim that the new vehicle attachment frame, when attached to an existing vehicle, gives that vehicle a new ornamental design from the dashboard back to the rear bumper as shown in FIG. 2, FIG. 3, and FIG. 10 model, left side view.

6. I claim that the vehicle attachment frame, when attached to an existing vehicle, gives that vehicle an ornamental design appearance of a scorpion as shown in FIG. 10.

7. I claim Scorpion as a name for this new vehicle invention.
